(19) United States
(12) Patent Application Publication
(10) Pub. No.: US 2006/0249224 A1
(43) Pub. Date: Nov. 9, 2006

(54) Dog days

(76) Inventor: William Gregory Ury, Cypress, TX (US)

Correspondence Address: WILLIAM G. URY, 18622 HAUGHLAND DR, CYPRESS, TX, 77433, US

(21) Appl. No.: 11/402,562

(22) Filed: Apr. 13, 2006

Related U.S. Application Data
(60) Provisional application No. 60/673,487, filed on Apr. 22, 2005.

(51) Int. Cl. B65B 1/04

(52) U.S. Cl. 141/98

(57) ABSTRACT

The best way to describe my invention is by the use of an automatic sprinkler system. You can efficiently fill a bowl with drinking water for your pet by installing a flood bubbler inside the bowl. The bowl is filled with water when the sprinkler system is in operation. Therefore, while you are watering your yard, you are also filling a bowl with fresh water for your pet. What is new about this invention is old water is flushed out of the bowl every time your sprinkler system is in operation, thus keeping the water clean.

### BACKGROUND

Dog Days can be classified under Residential Irrigation System, Underground Sprinkler System or a pet product. One of the biggest problems with the automatic watering bowls on the market now are the bowls are regulated by a float. A pet must drink the entire bowl of water to get a fresh bowl of water With Dog Days, the old water is flushed out and replaced with fresh water daily, depending on your sprinkler system setting. The sprinkler system can be set to a daily setting so the bowl will fill with fresh water daily. The water will remain clean because the sprinkler system will flush the debris out every time it is activated. I have also worked in the irrigation industry for over twenty years.

### SUMMARY

The substance of my invention is by the use of an underground irrigation system, you can efficiently fill a bowl with drinking water for your pet automatically. The advantage of my invention is that water in the bowl is replaced by fresh water. When the irrigation system activates, the zone on which the bowl is installed begins to add water into the bowl, causing the bowl to overflowing into a small gravel bed surrounding the bowl. This keeps the area around the bowl dry. If the bowl is in a programmed zone to come on daily, the bowl will fill with fresh water daily. The bowl can be installed on a separate zone or in a zone with sprinklers. The water level in the bowl is also regulated to how much water will fill the bowl by a flood bubble installed inside the bowl. A flood bubble is a commonly used product that is used for watering trees with an irrigation system.

### DESCRIPTION

The bowl will be made of a plastic material manufactured through an injection molding process. Plastic pellets are heated to a high temperature and under air pressure are injected into a mold made of heavy steel. When the plastic has cooled, the mold will be opened and the bowl taken out. This is a very common manufacturing method.

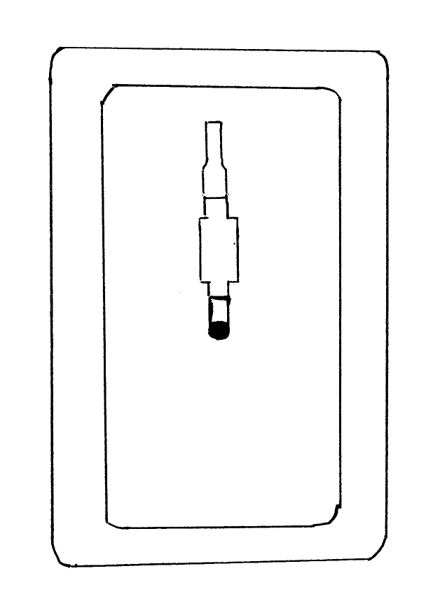

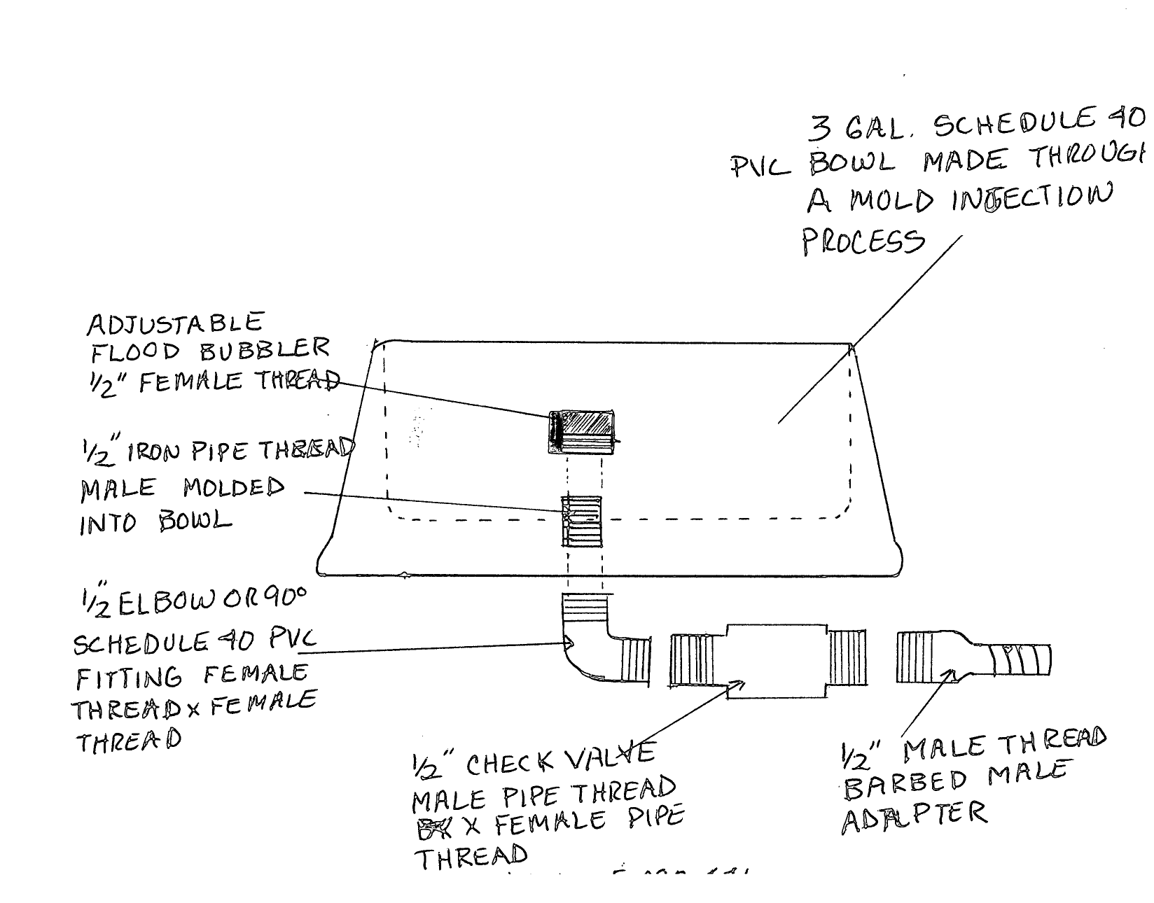

The bowl will then have a half-inch hole drilled through the center of it so that the flood bubble and the check valve can be installed. A half-inch closed nipple is threaded directly into the hole so that the flood bubbler and a half-inch threaded elbow can be attached, as seen in FIG. 5. Then the check valve is threaded into the elbow with a barbed fitting connected to the check valve. All parts are made of a half-inch iron pipe thread male and female for easy assembly. The barbed fitting is used to connect the fill line to the sprinkler system.

The fill line used will be a flexible polyethylene pipe, known as funny pipe or flex pipe, used in the irrigation industry for its flexibility. Funny pipe is used to connect a sprinkler head to a rigid PVC pipe to connect the bowl to the sprinkler system. A barbed tee is tied into the funny pipe on a sprinkler head, leaving you with one barbed fitting on the bowl and one barbed fitting that is tied into the sprinkler head. Then a piece of funny pipe is used to connect the two together.

A hole approximately 18×18×3 is dug where the bowl is to be located. The hole is then filled with pea gravel or small rock. The funny pipe connecting the bowl to the sprinkler is then buried and the bowl is placed in the center of the gravel bed. The bowl is now ready for operation. The irrigation system is equipped with a timer that allows you to operate the sprinkler system whenever desired.

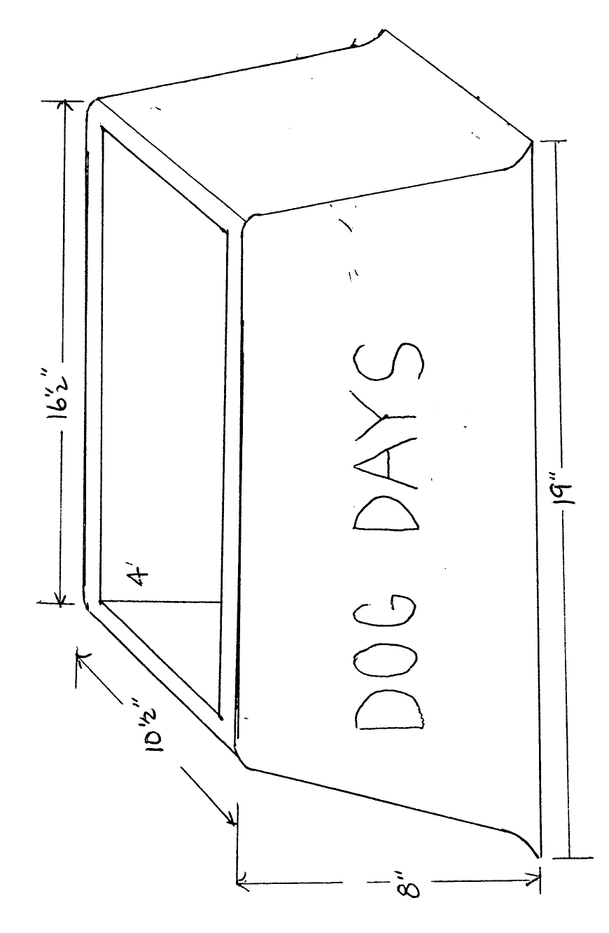

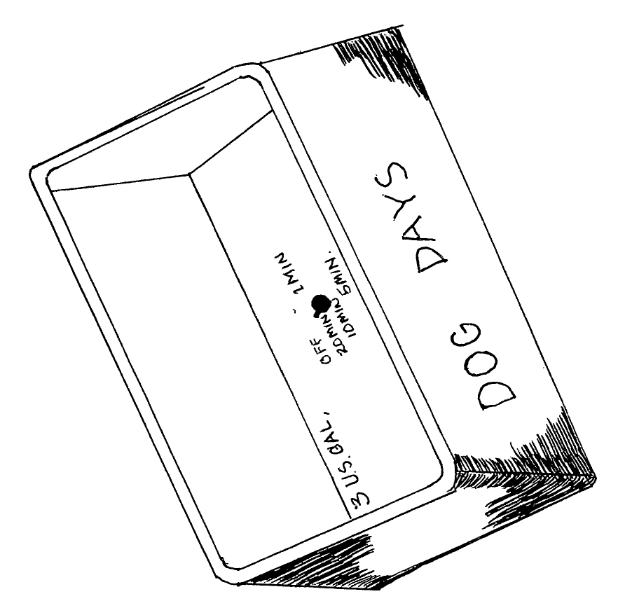

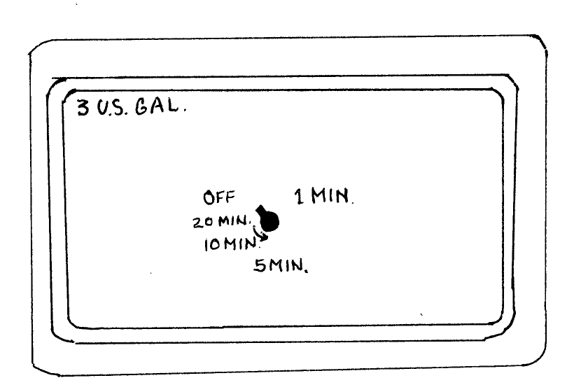

Most sprinkler systems have three to ten zones or valves. You must then locate the zone that the bowl is connected to. This should be done before instillation so you know the zone number to which the bowl is connected. You can also turn the system on to find the zone number. After the zone number is found, set the flood bubbler in the bowl as seen in FIG. 3 to match the amount of time on the timer. If the bowl is connected to zone five and runs for five minutes, simply turn the flood bubbler to five minutes. When the sprinkler system comes on, the bowl will fill with two and a half to three gallons of water in that five-minute period. The next time the sprinkler comes on; it will fill the bowl again pushing out the old water and debris into the gravel. The bowl can be shut off if desired as seen in FIG. 3.

1. What I claim as my invention is a bowl that is plumbed into an automatic sprinkler system that dispenses clean drinking water for your pet.
